(19) United States
(12) Patent Application Publication
(10) Pub. No.: US 2024/0148005 A1
(43) Pub. Date: May 9, 2024

(54) Mineral Oil And Water-Based Pesticide Formulations

(71) Applicant: Henkel AG & Co. KGaA, Düsseldorf (DE)

(72) Inventors: Daniel Thomas Piorkowski, Fairfield, CT (US); Anna Irene Peterson, Fairfield, CT (US); Eduard Monsonis Guell, Barcelona (ES); Mara Moreno Gomez, Barcelona (ES); Ana Garcia Manzanares, Barcelona (ES)

(21) Appl. No.: 18/356,947

(22) Filed: Jul. 21, 2023

Related U.S. Application Data
(60) Provisional application No. 63/382,448, filed on Nov. 4, 2022.

(51) Int. Cl. A01N 65/08; A01N 25/04; A01N 65/06; A01N 65/28; A01N 65/44; A01P 7/04

(52) U.S. Cl. CPC A01N 65/08; A01N 25/04; A01N 65/06; A01N 65/28; A01N 65/44; A01P 7/04

(57) ABSTRACT

A non-aqueous insecticidal composition includes a cottonseed oil in an amount of about 0.01 wt. % to about 5 wt. %, an ester solvent in an amount of about 1 to about 10 wt. %, and a mineral oil in an amount of about 55 wt. % to about 95 wt. %, wherein the composition is suitable for further dilution with water to form a sprayable preparation.

### FIELD OF THE INVENTION

This disclosure relates to mineral oil and water-based pesticide formulations. Specifically, the disclosure relates to mineral oil and water-based minimum risk pesticide formulations containing cottonseed oil, alone or together with other essential oils, and methods for using the same.

### BACKGROUND OF THE INVENTION

Insect pests, such as mosquitoes, flies, fleas, mites, and ticks, are known to be a nuisance to humans. Insect bites can cause discomfort or adverse inflammatory reactions. Some insects can carry bacterial and/or viral diseases that pose a significant health hazard to humans.

Accordingly, to kill, repel and/or control pests, insecticides or repellents are used in areas where the presence of these pests is not desired.

Synthetic chemical insecticides have historically provided effective means for controlling pests. However, there has been an increased concern that the widespread use of chemical insecticides has been detrimental to the environment and harmful to humans, animals, and beneficial insects. This is especially the case when chemical insecticides are used to treat larger areas, such as lawns or gardens. There has been increasing public concern that the amount of residual chemicals from synthetic insecticides that accumulate in the environment, including ground water and crops, can be toxic to humans, as well as domestic and wild animals and beneficial insects such as bees, butterflies, and other pollinators.

As a result, minimum risk pesticides are a growing sub-category in the insecticide marketplace. Essential oils are commonly used as the active material to kill a variety of pests, including ants, roaches, spiders, and flies. The essential oils are typically compounded with either mineral oil or water, along with other solvents. To kill insects, the consumer typically sprays the formula directly on the insect through a manual pump spray, aerosol, or garden hose attachment.

Water-based formulas provide a carrier (i.e., water) that has minimal risks. However, it is generally known that water-based formulas (even with those containing 1 to 25% mineral oil) typically have less efficacy on larger arthropods (like small or large roaches) than mineral oil-based formulas (65%+ mineral oil). Water-based formulas are generally as effective as mineral oil-based formulas against smaller insects such as ticks, fleas, and flies.

There is a consumer need for liquid insecticide formulations that can be applied to lawns and gardens to control pests, such as flying insects (mosquitos and flies) and crawling insects (ticks, fleas, ants). There is also a need for mineral oil-based and water-based insecticide formulations that utilize environmentally safe and/or minimum risk active insecticide ingredients. It is further desirable to provide a liquid insecticide formulation that may be continuously diluted and applied through a garden hose.

It is, therefore, an object of the present invention to improve upon existing lawn and garden insecticide formulations that can be continuously diluted and applied in a form of sprays over large areas.

It is also an object of the invention to provide an environmentally safe pesticide formulation containing minimum risk active insecticide ingredients.

It is further an object of the invention to provide a liquid pesticide formulation containing cotton seed oil to achieve improved dual benefits of efficacy and stability compared to the commercial products currently on the market.

### SUMMARY OF THE INVENTION

The foregoing is achieved by provision of minimum risk insecticide formulations containing cotton seed oil, either alone or in combination with one or more other essential oils. The inventive insecticide formulations can be diluted through continuous action of a garden hose for application to large target areas, such as lawns, gardens, etc.

In a first aspect, a non-aqueous insecticidal composition includes a cottonseed oil in an amount of about 0.01 wt. % to about 5 wt. %, an ester solvent in an amount of about 1 to about 10 wt. %, and a mineral oil in an amount of about 55 wt. % to about 95 wt. %. The composition is suitable for further dilution with water to form a sprayable preparation.

In some embodiments, the composition is essentially free from essential oils. In other embodiments, the composition includes at least one essential oil. In some of these embodiments, at least one essential oil is selected from the group consisting of clove oil, peppermint oil, lemongrass oil, cedarwood oil, geraniol, geranium oil, and wintergreen oil.

In some embodiments, the ester solvent includes one or more esters having a molecular weight of less than about 400. In certain of those embodiments, the ester solvent is selected from the group consisting of butyl lactate, ethyl lactate, triethyl citrate and combinations thereof.

In certain embodiments, the composition further includes isopropyl alcohol. The isopropyl alcohol may be present in the amount of about 10 wt. % to about 20 wt. % by eight of the composition.

In some embodiments, the composition may also include at least one of the following: an emulsifier, a preservative, a pH adjuster, and a thickener.

In some embodiments, the composition may be essentially free of water.

In a second aspect, an insecticidal composition is provided including a cottonseed oil present in an amount of 0.1 wt. % to about 10 wt. %, water present in an amount of at least about 75 wt. %, and at least one emulsifier present in an amount of about 0.1 wt. % to about 10 wt. %.

In some embodiments of the composition, the at least one emulsifier is sodium lauryl sulfate. In additional embodiments, at least one emulsifier is present in an amount of about 1 wt. % to about 5 wt. %.

In some embodiments, the composition may be essentially free of mineral oil. In other embodiments, the composition may be essentially free from essential oils.

In some cases, the composition may also include at least one ester solvent including one or more esters having a molecular weight of less than about 400.

In a third aspect of the invention, a method for controlling insects is provided, including the steps of providing an insecticidal composition including a cottonseed oil and a carrier, diluting the insecticidal composition with additional water such that one liter of the diluted composition is suitable to be applied to about 2,000 square feet to about 15,000 square feet of target surface, and applying the diluted insecticidal composition to the target surface.

In some embodiments, the step of diluting the insecticidal composition includes attaching a container filled with the insecticidal composition to a garden hose and passing water from the garden hose through the container.

In certain embodiments, at least 80% of arthropods are killed within 24 hours from exposure to the inventive composition.

In some embodiments, the carrier includes water, a mineral oil or mixtures thereof.

### DETAILED DESCRIPTION OF THE INVENTION

The following detailed description is merely exemplary in nature and is not intended to limit the disclosed pesticide formulations, or any associated methods for producing or using the same described herein. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

“At least one”, as used herein, relates to one or more, i.e., 1, 2, 3, 4, 5, 6, 7, 8, 9, or more. If used in combination with a compound, the term does not relate to the absolute number of molecules but rather to the number of different types of said compound. “At least one essential oil” thus means that at least one type but that also two or more different essential oils can be present.

The term “substantially”, as used herein, means at least about 80%, preferably at least about 90%, more preferably at least about 99%, for example at least about 99.9%. In some embodiments, the term substantially can mean completely, or about 100%.

As used herein, the term “comprising” means including, made up of, composed, characterized by or having.

“Free of”, as used herein in relation to a specific type of component, means that the referenced composition does not contain more than 0.5 wt. %, preferably no more than 0.1 wt. %, more preferably no more than 0.05 wt. % of said component relative to the total weight of the composition. Most preferably, said component is not contained at all.

As used in this specification and the associated claims, organic molecules may be represented using the notation of the letter C followed by a number, e.g., C12. The number indicates the number of carbon atoms in the associated organic molecule. The identified organic molecules need not be hydrocarbons but may include substitutions, for example, C3 polyols would include both glycerin and propylene glycol, both of which have three carbons in their structure and multiple hydroxyl substitutions.

The term “arthropod” refers to invertebrate animals with jointed limbs, a segmented body, and an exoskeleton. They belong to the phylum Arthropoda and include, but are not limited to insects, mites, spiders, ticks, arachnoids, arachnids, larvae, parasites, and like invertebrates.

The compositions and methods of the invention may be used to kill any type of arthropod, such as an insect. Exemplary arthropods that can be killed include but are not limited to beetles, cockroaches, flies, ants, larvae, lice, fleas, mosquitoes, mites, ticks, and the like. Exemplary arthropod orders can include but are not limited to orders Acariformes, Anoplura, Araneae, Blattodea, Coleoptera, Collembola, Diptera, Grylloptera, Hemiptera, Heteroptera, Homoptera, Isopoda, Isoptera, Ixodida, Mantodea, Mallophaga, Neuroptera, Odonata, Orthoptera, Parasitiformes, Psocoptera, Siphonaptera, Symphyla, Thysanura, and Thysanoptera, and the like.

The terms “insecticide formulation,” “insecticide composition”, “pesticide formulation,” and “pesticide composition” as used herein refers to a composition that causes at least about 1% of the exposed arthropods to die. In some embodiments, the terms encompass compositions that cause at least about 5%, at least about 10%, at least about 25%, at least about 50%, at least about 75% and at least about 90% of the exposed arthropods to die.

Absent explicit statement to the contrary, reference to wt. %, or wt %, or percent by weight, in the specification refers to the weight percentage of an ingredient as compared to the total weight of the insecticide composition. The wt. % of the total water in the liquid composition is calculated based on all the water including those added as a part of individual ingredients. When an ingredient added to make the liquid composition is not 100% pure and used as a mixture, e.g., in a form of a solution, the wt. % of that material added refers to the weight percentage of the mixture. Thus, a component which is 5 wt. % of the formulation, may be added as 5 wt. % of a pure component or 10 wt. % of solution that is 50% component and 50% water. Either result produces the recited 5 wt. % amount of the component in the resulting formulation. All percentages presented in this specification and the associated claims are weight percentages unless explicitly identified otherwise. If not indicated otherwise, all percentages refer to active matter and are by weight relative to the total weight of the composition.

The term “carrier” as used herein refers to an inert or fluid material, which may be inorganic or organic and of synthetic or natural origin, with which the active compound is mixed or formulated to facilitate its application to the object to be treated, or its storage, transport and/or handling.

The pesticide compositions of the present invention can be provided in the form of an oil-in-water emulsion, a water-in-oil emulsion, a micelle formulation, a solution, a suspension, a dispersion, and the like.

OilS

The pesticide compositions of the invention utilize one or more essential oils or vegetable oils as active pesticide ingredients. Suitable oils include, but are not limited to, those listed as Active Ingredients Eligible for Minimum Risk Pesticide Products by the United States Environmental Protection Agency (40 C.F.R. 152.25(f)(1)). The essential and vegetable oils usable here may include, but are not limited to, castor oil, cedarwood oil, cinnamon oil, citronella oil, clove oil, corn oil, cornmint oil, cottonseed oil, eugenol, garlic oil, geraniol, geranium oil, lemongrass oil, linseed oil, peppermint oil, rosemary oil, sesame oil, soybean oil, spearmint oil, thyme oil, and combinations thereof. Additional oils that may be used with the inventive pesticide compositions include, but are not limited to, betula oil, thymol, black seed oil, linalool, vanillin, isopropyl myristate, piperonal, pinenes, cymene, lilac flower oil, lime oil, cumin oil, mineral oil, olive oil, peanut oil, safflower oil, and combinations thereof.

In addition to the essential and vegetable oils, the inventive compositions may utilise one or more other active ingredients listed as Active Ingredients Eligible for Minimum Risk Pesticide Products by the EPA (40 C.F.R. 152.25(f)(1)). Such ingredients include, but are not limited to, citric acid, corn gluten meal, dried blood, lauryl sulfate, malic acid, 2-phenylethyl propionate, potassium sorbate, putrescent whole egg solids, sodium chloride, sodium lauryl sulfate, white pepper, zinc, and combinations thereof.

The essential and vegetable oils may be prepared from one or more plant parts, including but not limited to leaves, stems, bark, flowers, roots, seeds, and/or fruits. Additionally, the inventive compositions may optionally comprise one or more active components isolated from one or more essential oils.

In preferred embodiments, the pesticide compositions are essentially free from any active ingredients not listed as Active Ingredients Eligible for Minimum Risk Pesticide Products by the EPA (40 C.F.R. 152.25(f)(1)).

The essential oils may also have a secondary benefit of providing an olfaction effect to the pesticidal compositions, in addition to a pesticidal effect. In some embodiments, one or more essential oils described above are included in the inventive compositions to function as fragrances. Representative essential oils include floral or plant oil fragrances such as citrus, clove, eucalyptus, wintergreen, rosemary, citronella, or cinnamon oil, which also possesses pesticidal and antimicrobial properties. In some embodiments, the essential oils can also impart a beneficial property to the compositions, for example, where menthol is used as both a fragrance and an anti-itch component when the compositions are applied to human or animal skin.

The composition of the invention may also utilize one or more vegetable oils. Examples of a vegetable oil that may be used include, but are not limited to, soybean oil, safflower oil, olive oil, linseed oil, cottonseed oil, corn oil, coconut oil, cod liver oil, castor oil, hydrogenated castor oil, peanut oil, sperm oil, cocoa, palm-oil, wheat germ oil, sweet almond oil, sesame oil, hydrogenated soybean oil, soy lecithin, white mineral oil, hydrogenated cottonseed oil, hydrogenated palm-oils, rice bran oil, wheat oils, wintergreen oil, hydrogenated rapeseed oil, canola oil, hydrogenated castor oil, and any combinations thereof.

The oils may be used alone or in a combination of two or more oils. In the compositions including two or more oils, each oil can make up between about 0.1% to about 99%, by weight or volume, of the oil combination or mixture. In some embodiments, two oils are used in about 1:5 to about 5:1 ratio. In additional embodiments, the oils are used in about 1:3 to about 3:1 ratio. In some embodiments, two oils are used in about 1:2 to about 2:1 ratio. In some preferred embodiments, two oils are used in about 1:1 ratio.

In some embodiments, the insecticide composition comprises a mixture of three oils. In those embodiments, each of the oils may be present in an amount within a range of about 10% to about 90% of the oil mixture. In additional embodiment, each of the oils may be present in an amount within a range of about 20% to about 80% of the oil mixture, or within about 30% to about 70% of the oil mixture. In some preferable embodiments, each of the oils in the mixture is present in an amount within a range of about 30% to about 35% of the oil mixture.

In one preferred embodiment, the inventive pesticide composition contains cottonseed oil. The present inventors have found that cotton seed oil showed surprising efficacy when used alone. Prior to the invention, use of cottonseed oil to drive formula efficacy was not known. The present inventors have discovered, unexpectedly, that the inventive compositions achieve improved dual benefits of efficacy and stability, compared to the commercial products currently on the market.

Essential oils such as clove, peppermint, lemongrass, cedarwood, geraniol, geranium, wintergreen (among others) can also be used in addition to the cottonseed oil, partially replace the cottonseed oil or fully replace the cottonseed oil. Cottonseed oil is preferred to be in the system due to the low cost as compared to other essential oils and it is efficacious when combined with mineral oil.

Typically, the insecticide composition contains about 0.01 wt. % to about 25% total by weight of the composition of one or more essential or vegetable oils, preferably about 0.05 wt. % to about 15 wt. % of essential or vegetable oils, preferably about 0.05 wt. % to about 5 wt. % of essential or vegetable oils, more preferably about 0.5 wt. % to about 5 wt. % of essential or vegetable oils.

In some embodiments, the essential oils may also act as passive or inert composition ingredient, including, but not limited to, as a carrier, a diluent or a dispersant to assist in distributing or spreading the active insecticide ingredient(s).

Mineral Oil

The pesticide formulations of the present invention may be water-based, oil-based formulations or combinations of those formulations. In some embodiments, the inventive pesticide compositions are oil-based compositions that are essentially free of water. In these embodiments, the pesticide compositions typically include a mineral oil component that functions as a solvent/diluent and/or carrier. Such mineral oil-based pesticide compositions may be preferable because they are more efficacious on larger arthropods (like small or large roaches), in addition to smaller arthropods, such as ticks, fleas, and flies.

Mineral oil may function as a carrier oil to provide residual killing power on surfaces for up to, as much as, four weeks or more. The essential oil is dissolved in the carrier oil and prevents the rather volatile essential oil from evaporating quickly. As a result, the insects come in contact with the carrier oil composition that will eventually kill them.

Many other oils other than mineral oil are capable of performing the function of the carrier oil and may also be used with the inventive pesticide compositions. Examples of such oils includes, but are not limited to, soybean oil, canola oil, corn oil, sunflower oil, neem oil, peanut oil, sesame oil, cottonseed oil, fish oil, olive oil, safflower oil, or castor oil. In some embodiments, Wintergreen oil and Wheat Germ Oil can be used in place of mineral oil.

The inventive pesticide composition may utilize any suitable mineral oils. In a preferred embodiment, the pesticide compositions utilize a mineral oil that is paraffinic and has a kinetic viscosity of about 10 to 20 cSt at 40° C. (ASTM D445), as well as a Saybolt Universal Viscosity of about 70 at 100° F. (ASTM D2161). PURETOL™ 7 from Petro-Canada is an exemplary oil that fits this definition. PURETOL™ 7 is an odorless and colorless white mineral oil with a Saybolt viscosity of 70 and a specific gravity of 0.853.

A food-grade mineral oil is not required but is preferred for the pesticide compositions of the present invention.

In some embodiments, mineral oil is present in an amount of from about 1 to about 95 weight percent, or from about 10 to about 90 weight percent by weight of the pesticide composition. Preferably, mineral oil is present in an amount of about 60 percent to about 85 percent by weight of the pesticide composition and more preferably in about 70 percent by eight to about 80 percent by weight of the pesticide composition.

Water

In some embodiments, the inventive pesticide compositions are water-based formulations that are essentially free of mineral oil. Water-based formulations may be advantageous when they are applied to a large surface area by being diluted with additional water, such as when applied via a conventional garden hose. Water-based formulations may also have the advantage of not leaving behind an oily residue, which may be desirable for certain treatment surfaces, such as plants, outdoor deck and furniture, etc.

Water is used as a solvent and carrier to disperse the pesticide formulation over the treatment area.

In some embodiments, water is present in an amount of from about 5 to about 95 weight percent, from about 25 to about 95 weight percent, from about 50 to about 95 weight percent, or from about 75 to about 95 weight percent. In other embodiments, water is present in an amount of from about 30 to about 80 weight percent, from about 55 to about 85 weight percent, from about 70 to about 80 weight percent, or from about 80 to about 90 weight percent. Preferably, water is present at not less than about 50 percent by weight of the pesticide composition, or not less than about 75 percent by weight of the pesticide composition, or not less than about 85 percent by weight of the pesticide composition.

Water may be added to the detergent composition directly or as a component of other ingredients, or directly and as a component of other ingredients.

Solvents

The inventive pesticide composition may include various solvents.

In the water-based composition, a solvent serves to reduce the water-oil surface tension of the emulsion or composition. By reducing the surface tension, the oil spots containing pesticidal essential oil components are more readily dispersed in the water, and a thin film of the oil-water mixture is formed on the treated surfaces. The solvent may also serve as a carrier and a synergist. The solvent may assist in fast penetration through the cell membrane of an arthropod being controlled to ensure the arrival of sufficient active ingredients to the site of action. The solvent may assist in wetting the arthropod exoskeleton to facilitate exposure of the cell membrane to the formulation and/or may dissolve portions of the exoskeleton.

Various solvents may be used in accordance with the present invention, either alone or in combination of two or more solvents. One suitable solvent is mineral oil, as discussed above. Additional suitable solvents include, but are not limited to, lower alcohols or esters having a molecular weight of less than 400.

In some embodiments, the inventive pesticide compositions include citric acid esters and/or lactic acid esters, including but not limited to triethyl citrate, ethyl lactate and butyl lactate and mixtures thereof. These solvents may be present in an amount of about 0.01 wt. % to about 25 wt. %, or about 1 wt. % to about 15 wt. %, or about 1 wt. % to about 5 wt. % by weight of the inventive pesticide composition. In some preferred embodiments, triethyl citrate, ethyl lactate and butyl lactate solvents, or a mixture thereof, are present in an amount of about 2 wt. % to about 3 wt. %.

In certain embodiments of the oil-based pesticidal composition, isopropyl alcohol as used as a co-solvent, as discussed in more detail below.

In additional embodiments, the pesticidal composition further includes isopropyl myristate as an additional solvent. Isopropyl myristate may be present in an amount of about 1 wt. % to about 10 wt. %, preferably about 2 wt. % to about 8 wt. %, and more preferably about 4 wt. % to about 6 wt. %.

Surface Active Agents

The inventive compositions may further utilize surface active agents. Surface active agents function as emulsifying and dispersing agents to distribute the active essential oil ingredients in the water-based or an oil-in-water emulsion composition. The particular type of dispersing and emulsifying agents and the amount employed may be chosen based on the nature of the composition and the ability of the agent to facilitate the dispersion of the pesticidal compositions of the present invention.

The emulsifier may be any suitable compound or mixture of compounds. Embodiments of suitable emulsifiers include one or more cationic emulsifiers, anionic emulsifiers, and non-ionic emulsifiers, and mixtures thereof. For example, suitable emulsifiers may include, but are not limited to, fatty acids, esterified fatty acids, soaps, lecithin, polyethylene oxide esters of fatty acids, polyethylene oxide ethers of fatty alcohols, cyclodextrins, alkyl sulfates, alkyl sulfonates, aryl sulfonates, the condensation products of alkylene oxides with phenol and organic acids, complex ether alcohols, quaternary ammonium compounds, and the like.

In one embodiment, one or more fatty acids are used as surface active agent in the inventive pesticide composition. As used herein, the term “fatty acids” refers to alkyl chains having a carboxylic acid substituent at one end of the alkyl chain and a methyl (CH₃) substituent at the other end of the alkyl chain. Such fatty acids may be saturated or unsaturated. The term “long chain fatty acids” as used herein refers to alkyl chains having 14 to 24 carbon atoms. Fatty acids of fewer than fourteen carbon atoms are referred to herein by their carboxylic acid name, such as hexanoic acid, heptanoic acid, octanoic acid, nonanoic acid, decanoic acid, undecanoic acid, dodecanoic acid, etc.

In one embodiment, the fatty acid includes a fatty acid selected from among soy, soybean, coconut, castor, rapeseed, canola, silicone, and paraffin fatty acids. In one preferred embodiment, a coconut fatty acid is used. In additional embodiments, polyglycerol oleate is used in the compositions of the present invention.

In additional embodiments, one or more alkyl sulfates are used. In one example, Sodium Lauryl Sulfate (SLS) may be used to disperse/emulsify a water-based or an oil-in-water emulsion composition.

In one embodiment, the amount of emulsifiers/dispersing agents (or other suitable surface-active agents) in the composition is preferably in the range from about 0.01 wt. % to 50 wt. %, or from about 0.1 wt. % to about 30 wt. %, or from about 1 wt. % to about 20 wt. % by weight of the pesticide composition. In some preferred embodiments, emulsifiers/dispersing agents are present in an amount of about 1 wt. % to about 10 wt. %, and more preferably about 1 wt. % to about 5 wt. % by weight of the composition.

Isopropyl Alcohol

The inventors have found that the use of isopropyl alcohol—2-propanol—in a liquid pesticide composition has a positive effect on volatilization of essential oils. After the pesticide formulation is applied, e.g., by direct spraying of a pest or application to a larger area containing pests, isopropyl alcohol volatizes and facilitates volatilization of active insecticide essential oils to achieve distribution over a larger area of control. It has been found that the inventive pesticide compositions containing isopropyl alcohol achieve better volatilization than pesticide compositions without isopropyl alcohol, such as e.g., containing only water and/or mineral oil as carriers. Prior to the invention, it was neither known nor obvious that certain small levels of isopropyl alcohol would improve the volatilization of the essential oils.

It is understood that the inventive pesticide compositions may also be prepared without the use of isopropyl alcohol.

Isopropyl alcohol suitable for the inventive formulations may be of different purity grades. In one embodiment, 70% pure isopropyl alcohol is used. In a more preferred embodiment, the insecticide formulation contains 99% pure isopropyl alcohol.

In some embodiments, isopropyl alcohol is present in an amount of from about 0 to about 25 wt. %, from about 1 to about 20 wt. %, or from about 5 to about 15 wt. %. In some preferred embodiments, isopropyl alcohol is present in an amount of about 15 wt. % by the weight of the inventive pesticide composition.

Other Ingredients

Embodiments of the present invention can various other ingredients known in the art to be typically used in such formulations. These ingredients can include, but are not limited to, fillers, dispersants, water or other solvent medium or media, surfactants, suspension agents, sticking agents, stabilizers, preservatives, dyes, pigments, masking agents, emollients, excipients, post-application detection agents, additional active ingredients, antifoaming agents, anti-microbial agents, anti-oxidants, emulsifiers, fats, fluorescent materials, fungicides, hydrotropes, optical brighteners, perfume carriers, perfume, proteins, silicones, solubilizers, sugar derivatives, waxes, and the like.

The compositions of the present invention may also include additional active ingredients such as, for example, additional pest-combating ingredients, such as repellents and/or cidal agents. By way of example, the compositions may be formulated with an insect repellent ingredient. The repellents/cidal agents are preferably, but not necessarily, naturally occurring agents.

Surfactants

Surfactants are well known in the art, and any combination of suitable surfactants or surfactant systems can be used in the pesticidal compositions described herein. Surfactants may function to modify the properties of the carrier to increase the dispersion and/or suspension of the active pesticide agents in an aqueous solution (i.e., stabilize an oil-in-water emulsion when the pesticide composition is diluted with water). Further, by modifying the carrier to increase dispersion and/or suspension of the active pesticide agents in aqueous solution, the pesticide agents will be able to be effectively delivered (e.g., via a sprayer) without the active sticking/adhering to the inner walls of the delivery device or clogging delivery components (e.g., sprayer nozzle, sprayer tubing, etc.).

The compositions of the invention may contain one or more surfactants. Useful surfactants in the pesticidal compositions of the present invention include, for example, an anionic surfactant, a nonionic surfactant, a cationic surfactant, an ampholytic surfactant, a zwitterionic surfactant, and/or mixtures thereof. The use of multiple surfactants of a particular type or a distribution of different weights of a surfactant may be particularly useful.

Suitable anionic surfactants are alkali metal, alkaline earth metal or ammonium salts of sulfonates, sulfates, phosphates or carboxylates. Examples of sulfonates are alkylarylsulfonates, diphenylsulfonates, alpha-olefinsulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides.

Suitable cationic surfactants are quaternary surfactants, for example quaternary ammonium compounds with one or two hydrophobic groups, or salts of long-chain primary amines. Suitable amphoteric surfactants are alkylbetaines and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali metal salts of polyacrylic acid. Examples of polybases are polyvinylamines or polyethyleneamines.

The composition according to the invention can comprise various amounts of surfactants. It can comprise from 0.1 to 40% by weight, preferably from 1 to 30% by weight, more preferably from 2 to 20% by weight, and in particular from 2 to 10% by weight of total amount of surfactants, based on the total amount of the composition.

pH Adjusting Agents

pH adjusting agents may be added to and included in the pesticide compositions. Exemplary pH adjusting agents include monoethanol amine, binary amines, buffers, triethanol amine, metal hydroxides, or other materials. Exemplary metal hydroxides are sodium hydroxide and/or potassium hydroxide, and other possible pH adjusting agents include compounds that adjust the pH of the composition, such as citric acid.

pH adjusting agents may be present in the pesticide composition at an amount of from about 0 to about 10 weight percent in some embodiments, based on the total weight of the composition, but in other embodiments the pH adjusting agent may be present in the wash composition at an amount of from about 0.5 to about 5 weight percent, or an amount of from about 0.5 to about 3 weight percent, based on the total weight of the composition. In preferred embodiments, the pH adjusting agents are present in an amount of about 0 to about 0.5 weight percent, based on the total weight of the composition.

The pH adjusting agent may be utilized to adjust the pH of the pesticide composition to from about 2 to about 8, or from about 3 to about 6.5 in various embodiments.

The pH adjusting agent may form a cation that combines with an anionic surfactant and/or a coconut fatty acid and/or another anionic component within the composition. In many cases, the pH adjusting agent forms a salt with an anionic component. As such, the anionic surfactant may be present in the composition as a surfactant salt, and the coconut fatty acid may be present in the composition as a coconut fatty acid salt. In some embodiments, the pH adjusting agent is included in a slight excess relative to the anionic surfactant or other acidic components to adjust the pH of the composition to within a desired range, such as the range(s) mentioned above. As used herein, the terms “anionic surfactant” and “coconut fatty acid” include the neutralization products thereof.

Humectants

A humectant, for purposes of the present invention, is a substance that exhibits high affinity for water, especially attracting water for moisturization and solubilization purposes. The water is absorbed into the humectant; not merely adsorbed at a surface layer. The water absorbed by the humectant is available to the system; the water is not too tightly bound to the humectant. Humectants possess hydrophilic groups which form hydrogen bonds with water. Common hydrophilic groups include hydroxyl, carboxyl, ester, and amine functionalities. A humectant can thus act as a solubilizer and moisture regulator in a composition.

Useful humectants include but not limited to polyols. The polyol (or polyhydric alcohol) may be a linear or branched alcohol with two or more hydroxyl groups. Thus, diols with two hydroxyl groups attached to separate carbon atoms in an aliphatic chain may also be used. The polyol typically includes less than 9 carbon atoms, such as 9, 8, 7, 6, 5, 4, 3, or 2 carbon atoms. Preferably, the polyol includes 3 to 8 carbon atoms. More preferably, the polyol includes 3 to 6 carbon atoms. The molecular weight is typically less than 500 g/mol, such as less than 400 g/mol or less than 300 g/mol.

Embodiments of suitable polyols include, but not limited to: propylene glycol, butylene glycol, pentylene glycol, hexylene glycol, heptylene glycol, octylene glycol, 2-methyl-1,3-propanediol, xylitol, sorbitol, mannitol, diethylene glycol, triethylene glycol, glycerol, erythritol, dulcitol, inositol, and adonitol.

The pesticide compositions of the present invention may contain about 5 wt. % to about 75 wt. % of one or more humectants, or about 7 wt. % to about 50 wt. %, or about 10 wt. % to about 40 wt. %, or about 20 to 30 wt. % of one or more C2 to C5 polyols.

Preservatives

In order to provide a reasonable shelf-life to the inventive pesticidal compositions, it is preferable that a preservative be added to the composition. Any suitable commercially available preservatives may be used with the inventive compositions.

One such suitable preservative is sodium benzoate commercially available preservatives used for preserving food, as would be known to those of ordinary skill in the art, may also be suitably used. Examples of suitable preservatives include, but are not limited to, formaldehyde, alkyl esters of p-hydroxybenzoic acid, sodium benzoate, potassium sorbate, 2-bromo-2-nitropropan-1,3-diol, o-phenylphenol, thiazolinones such as benzisothiazolinone, 5-chloro-2-methyl-4-30 isothiazolinone, pentachlorophenol, 2,4-dichlorobenzyl alcohol, citric acid, and mixtures thereof. In one preferred embodiment, the pesticidal composition includes potassium sorbate as a preservative. In another embodiment, the composition of the invention may also include citric acid as a preservative.

The pesticide compositions of the present invention may contain about 0.001 wt. % to about 5 wt. % of one or more preservatives, or about 0.01 wt. % to about 2 wt. %, or about 0.1 wt. % to about 0.3 wt. % of one or more preservatives.

Colorants

Further, the pesticide compositions of the present invention may additionally contain a coloring agent or colorant. In some embodiments, the pesticide composition contains one or more colorants. Suitable examples of such coloring agents or colorants that may be utilized include, but are not limited to, inorganic pigments such as metal oxides, titanium oxides and Prussian blue, organic dyes such as alizarine dyes, azodyes and metallic phthalocyanine dyes, iron, manganese, boron, copper, cobalt, molybdenum, zinc and salts thereof, and the like, or a mixture thereof.

The colorant(s) can be, for example, polymers. The colorant(s) can be, for example, dyes. The colorant(s) can be, for example, water-soluble polymeric colorants. The colorant(s) can be, for example, water-soluble dyes. The colorant(s) can be, for example, colorants that are well-known in the art or commercially available from dye or chemical manufacturers. The color of the colorant(s) is not limited, and can be, for example, red, orange, yellow, blue, indigo, violet, or any combination thereof.

The total amount of the one or more colorant(s) that can be contained in the pesticidal composition, for example, can range from about 0.00001 wt. % to about 0.099 wt. %. The total amount of colorant(s) in the pesticidal composition can be, for example, about 0.0001 wt. %, about 0.001 wt. %, about 0.01 wt. %, about 0.05 wt. %, or about 0.08 wt. %.

Bittering Agents

Bittering agents may optionally be added to hinder accidental ingestion of the pesticidal composition. Bittering agents are compositions that taste bad, so children or others are discouraged from accidental ingestion. Exemplary bittering agents include denatonium benzoate, aloin, and others. Bittering agents may be present in the wash composition at an amount of from about 0 to about 1 weight percent, or an amount of from about 0.001 to about 0.5 weight percent, or an amount of from about 0.001 to about 0.25 weight percent in various embodiments, based on the total weight of the pesticidal composition.

Methods of Use

The compositions of the present invention may be used to eliminate arthropods either by direct application to a host, such as human, animal or plant, or by treatment of an area within which a host is located.

In some embodiments, the pesticidal compositions are distributed over a larger area, such as lawn or garden, to kill targets located therein. In these embodiments, the pesticidal composition may be provided in a concentrated form to be further diluted with additional water. In one embodiment, the pesticide composition is diluted with water at a ratio of about 0.01 to about 5 parts of the pesticide composition to about 95 to 99.99 parts of water. In further embodiments, the pesticide composition is diluted with water to a ratio of about 5 parts of the composition to about 95 parts of water, or about 4 parts of the composition to about 94 parts of water, or about 3 parts of the composition to about 97 parts of water. Preferably, the dilution is such that one litre or 33 fluid ounces of the diluted composition is suitable to be applied to about 2,000 square feet to about 15,000 square feet of target surface. The diluted composition is then sprayed over the target area by any suitable method.

The pesticidal composition may be diluted with water by attaching a container containing the composition to a garden hose or any other water supplying device. Water is then passed from the hose through the container to continuously dilute the pesticidal composition in the container with additional water. The diluted composition is then sprayed from the container under the pressure of the water hose to the target area.

Once the pesticidal composition of the present invention is applied to a target area, it is effective at killing a certain percentage of arthropods within a certain time period. In some embodiments, at least 75% of arthropods are killed within 24 hours from exposure. In additional embodiments, at least 90% of arthropods are killed within 24 hours from exposure. In further embodiments, at least 50% of arthropods are killed within 30 seconds of exposure and at least 90% of arthropods are killed within 30 minutes of exposure. In other embodiments, at least 25% of arthropods are killed within 30 minutes of exposure, and at least 35% of arthropods are killed within 1 hour of exposure, and at least 40% of arthropods are killed within 1 hour from exposure.

In other embodiments, the pesticidal composition may be provided in a form of a pressurized aerosol or a trigger spray. The aerosol/spray is used to spray a host (human, animal, etc.) or a target area where arthropods may be located. Mixtures of liquefied hydrocarbons, such as propellants A-46, A-70, or 142A, may be used as propellants in embodiments of spray mixtures. Additional propellants may include butane gas, propane gas, liquid petroleum gas, dimethyl ether, carbon dioxide, and the like, and a mixture thereof.

### EXAMPLES

All compositions described below are given in % weight of each material included in the formula.

### Example 1

The following batches were made using a standard over-head mixer (Caframo Stirrer BDC3030), with the rpm set between 200-400 to provide sufficient agitation. Order of addition may vary, but in this particular example, the order of addition was mineral oil, isopropyl alcohol, isopropyl myristate, butyl lactate, triethyl citrate, and then the essential oils.

All formulas showed good stability (no phase separation or discolouring) at 25° C., 45° C., 54° C.; but had some phase separation at both 4° C. and −20° C. when stored in glass or PET bottles. All formulas were water white and transparent. The formulas can be packaged in PET or HDPE bottles.

All formulas had a viscosity of approximately 5 to 30 centipoises (cP) at 25° C.

TABLE 1

| | % Inclusion | | |
|---|---|---|---|
| Component | Formula 1 | Formula 2 | Formula 3 |
| (White) Mineral Oil | 77.75 | 77.75 | 77.75 |
| Isopropyl Alcohol | 15 | 15 | 15 |
| Isopropyl Myristate | 4.5 | 4.35 | 4.5 |
| n-Butyl Lactate | 1.5 | 1.5 | 1.5 |
| Triethyl Citrate | 0.75 | 0.75 | 0.75 |
| Lemongrass Oil | 0.167 | 0.15 | |
| Clove Oil | 0.167 | | |
| Cottonseed Oil | 0.167 | 0.35 | 0.5 |
| Cedarwood Oil | | 0.15 | |
| TOTAL | 100 | 100 | 100 |

In the above Formulas 1-3, the essential oils are used as the active pesticide component, mineral oil is added to distribute the essential oil in the mixture, isopropyl alcohol is used to distribute the essential oils as well as a fragrance bloom after application, isopropyl myristate is added to distribute the essential oil in the mixture, and n-Butyl Lactate and Triethyl Citrate are added as emulsifiers.

Essential oils such as clove, peppermint, lemongrass, cedarwood, geraniol, geranium, and wintergreen, among others, can also be used in addition to the cottonseed oil, partially replace the cottonseed oil or fully replace the cottonseed oil. Cottonseed oil is preferred to be in the system because the inventors discovered that it is efficacious when combined with mineral oil and also due to its low cost as compared to other essential oils.

Furthermore, solvents such as triethyl citrate, butyl lactate and ethyl lactate can be varied to provide better liquid stability (phase separation) of the inventive pesticide composition.

### Example 2

The formulas in Example 1 were tested at an external lab, using trigger sprays (0.85 constant current (cc) output) at about 12 inches distance on small German cockroaches or Argentine Ant (1 trigger spray against each insect), and trigger sprays on large American cockroaches (two trigger sprays against the insect). All of the formulas attained over 80% kill rate at 24 hours. Formula 1 is marked as AIP-02-187 and Formula 2 is marked as AIP-02-188, and Formula 3 is marked as AIP-02-190 in below tables.

Test results against German cockroaches are shown in Table 2 below:

TABLE 2

| | [symbol] | Percent Mortality | | | | | | |
|---|---|---|---|---|---|---|---|---|
| Mix Rate: | on | Pre-trt | 30 sec | 30 min | 1 hr | 2 hr | 4 hr | 24 hr |
| Control—Untreated | N/A | 0% | 0% | 0% | 0% | 0% | 0% | 0% |
| AIP-02-187 | 1 trigger p | 0% | 0% | 100% | 100% | 100% | 100% | 100% |
| AIP-02-188 | 1 trigger p | 0% | 5% | 100% | 95% | 100% | 100% | 100% |
| AIP-02-190 | 1 trigger p | 0% | 5% | 95% | 98% | 98% | 100% | 100% |

[symbol]

indicates data missing or illegible when filed

Test results against Argentine Ants are shown in Table 3 below:

TABLE 3

| | [symbol] | Percent Mortality | | | | | | |
|---|---|---|---|---|---|---|---|---|
| Mix Rate: | on | Pre-trt | 30 sec | 30 min | 1 hr | 2 hr | 4 hr | 24 hr |
| Control—Untreated | N/A | 0% | 0% | 0% | 0% | 0% | 0% | 0% |
| AIP-02-187 | 1 trigger p | 0% | 70% | 100% | 100% | 100% | 100% | 100% |
| AIP-02-188 | 1 trigger p | 0% | 65% | 100% | 100% | 100% | 100% | 100% |
| AIP-02-190 | 1 trigger p | 0% | 70% | 100% | 100% | 100% | 100% | 100% |

[symbol]

indicates data missing or illegible when filed

Test results against American cockroaches are shown in Table 4 below:

TABLE 4

| | [symbol] | | | | | | | | |
|---|---|---|---|---|---|---|---|---|---|
| Mix Rate: | on | Pre-trt | 30 sec | 30 min | 1 hr | 2 hr | 4 hr | 24 hr | 2 DAE |
| Control—Untreated | N/A | 0% | 0% | 0% | 0% | 0% | 0% | 0% | 0% |
| AIP-02-187 | 2 trigger p | 0% | 0% | 30% | 35% | 45% | 40% | 93% | 100% |
| AIP-02-188 | 2 trigger p | 0% | 0% | 25% | 38% | 30% | 40% | 95% | 100% |
| AIP-02-190 | 2 trigger p | 0% | 0% | 53% | 50% | 50% | 50% | 98% | 100% |

[symbol]

indicates data missing or illegible when filed

As can be seen from the test data in Tables 2-4, the pesticide composition containing cottonseed oil only (Formula 3) was just as efficacious against German cockroaches and Argentine ants as the other compositions (Formulas 1 and 2) containing cottonseed oil in combination with other essential oils (e.g., lemongrass oil, clove oil and/or cedarwood oil). For American cockroaches, Formula 3 with cottonseed oil only was more efficacious than the other two compositions.

Formula 3 includes about 0.5 wt. % cottonseed oil. However, the present inventors expect the formula to maintain the same efficacy and/or improved efficacy if cottonseed oil is provided at 1 wt. % or higher, such as 5 wt. %.

### Example 3

The following batches replaced solvent such as mineral oil with water and emulsifier (Sodium Lauryl Sulfate). This formulation can be advantageous to the consumer since the formula below can be cleaned up from surfaces after use easier (i.e., if the formula is sprayed on hardwood floors to kill insects).

TABLE 5

| | % Inclusion | | | |
|---|---|---|---|---|
| Component | Formula 4 | Formula 5 | Formula 6 | Formula 7 |
| Water | 93.2 | 93.2 | 88.9 | 88.9 |
| Sodium Lauryl | 1.75 | 1.75 | 3.5 | 3.5 |
| Sulfate | | | | |
| Citric Acid | 0.023 | 0.023 | 0.023 | 0.023 |
| Potassium | 0.05 | 0.05 | 0.05 | 0.05 |
| Sorbate | | | | |
| Ethyl Lactate | 2.5 | | 2.5 | |
| Butyl Lactate | | 2.5 | | 2.5 |
| Cottonseed Oil | 2.5 | 2.5 | 5 | 5 |
| Total | 100.00 | 100.00 | 100.00 | 100.00 |

Essential oils such as clove, peppermint, lemongrass, cedarwood, geraniol, geranium, wintergreen (among others) can also be used in addition to the cottonseed oil, partially replace the cottonseed oil or fully replace the cottonseed oil.

Furthermore, solvents such as triethyl citrate, butyl lactate and ethyl lactate can be varied to provide better emulsion stability (gravitational separation rate).

The above formulas were created by adding Potassium Sorbate to Water, then Citric Acid, SLS, Ethyl or Butyl Lacate and then the vegetable (Cottonseed) or essential oil. The mixture was created using a standard over-head mixer (Caframo Stirrer BDC3030), with the rpm set between 200-400 to provide sufficient agitation. After mixing for 2 minutes, the mixture was transferred to a Ross HSM-100LCI high-shear mixer and mixed at 2500 rpm for 2 minutes using a slotted stator screen. Particle sizes observed were about 2 to 15 microns.

In the above Formulas 4-7, cottonseed oil is used as the active pesticide component, Sodium Lauryl Sulfate is used to emulsify the oil, Ethyl or Butyl Lacate are used as solvents for the oil to distribute the oil in the mixture, citric acid to lower the pH, potassium sorbate/citric acid to preserve the liquid to microbes, and water being the balance of the formula.

Although the above components were added in an order as described above, the method of the present invention is not limited to the particular order. As long as the resulting product can reach the desired viscosity, particle size, and stability, etc., any method that prepares the product is within the scope of the invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

What is claimed is:

1. A non-aqueous insecticidal composition comprising:
a cottonseed oil in an amount of about 0.01 wt. % to about 5 wt. %,
an ester solvent in an amount of about 1 to about 10 wt. %, and
a mineral oil in an amount of about 55 wt. % to about 95 wt. %,
wherein the composition is suitable for further dilution with water to form a sprayable preparation.

2. The insecticidal composition of claim 1, wherein the composition is essentially free from essential oils.

3. The insecticidal composition of claim 1, further comprising at least one essential oil.

4. The insecticidal composition of claim 3, wherein the at least one essential oil is selected from the group consisting of clove oil, peppermint oil, lemongrass oil, cedarwood oil, geraniol, geranium oil, and wintergreen oil.

5. The insecticidal composition of claim 1, wherein the ester solvent comprises one or more esters having a molecular weight of less than about 400.

6. The insecticidal composition of claim 5, wherein the ester solvent is selected from the group consisting of butyl lactate, ethyl lactate, triethyl citrate and combinations thereof.

7. The insecticidal composition of claim 1, further comprising isopropyl alcohol.

8. The insecticidal composition of claim 7, wherein the isopropyl alcohol comprises about 10 wt. % to about 20 wt. %.

9. The insecticidal composition of claim 1, further comprising at least one of the following: an emulsifier, a preservative, a pH adjuster, and a thickener.

10. The insecticidal composition of claim 1, wherein the composition is essentially free of water.

11. An insecticidal composition comprising:
a cottonseed oil present in an amount of 0.1 wt. % to about 10 wt. %, water present in an amount of at least about 75 wt. %, and
at least one emulsifier present in an amount of about 0.1 wt. % to about 10 wt. %.

12. The insecticidal composition of claim 11, wherein the at least one emulsifier is sodium lauryl sulfate.

13. The insecticidal composition of claim 11, wherein the at least one emulsifier is present in an amount of about 1 wt. % to about 5 wt. %.

14. The insecticidal composition of claim 11, wherein the composition is essentially free of mineral oil.

15. The insecticidal composition of claim 11, wherein the composition is essentially free from essential oils.

16. The insecticidal composition of claim 11, further comprising at least one ester solvent comprising one or more esters having a molecular weight of less than about 400.

17. A method for controlling insects, comprising the steps of:
providing an insecticidal composition comprising:
a cottonseed oil, and
a carrier,
diluting the insecticidal composition with water such that one liter of the diluted composition is suitable to be applied to about 2,000 square feet to about 15,000 square feet of target surface, and
applying the diluted insecticidal composition to the target surface.

18. The method of claim 17, wherein the step of diluting the insecticidal composition comprises attaching a container filled with the insecticidal composition to a garden hose and passing water from the garden hose through the container.

19. The method of claim 17, wherein at least 80% of arthropods are killed within 24 hours from exposure.

20. The method of claim 17, wherein the carrier comprises water, a mineral oil or mixtures thereof.
